(19) United States
(12) Patent Application Publication
(10) Pub. No.: US 2012/0023109 A1
(43) Pub. Date: Jan. 26, 2012

(54) Contextual processing of data objects in a multi-dimensional information space

(75) Inventors: Karl-Heinz Sternemann, Buhlertal (DE); Christoph Wilfert, Sammamish, WA (US)

(73) Assignee: Viprocom, Hunenberg (CH)

(21) Appl. No.: 13/135,775

(22) Filed: Jul. 13, 2011

Related U.S. Application Data
(60) Provisional application No. 61/363,949, filed on Jul. 13, 2010.

(51) Int. Cl. G06F 17/30

(52) U.S. Cl. 707/748; 707/736; 707/752; 707/E17.009; 707/E17.045

(57) ABSTRACT

A system and method is disclosed for contextual processing of data objects in a multi-dimensional information space. The system can be used to increase the efficiency and improve the interactive experience for the user of a GUI-based operating system or application.

### CROSS-REFERENCE TO RELATED APPLICATION

This application claims priority to U.S. Provisional Application No. 61/363,949, filed 13 Jul. 2010, which is incorporated by reference herein in its entirety.

### BACKGROUND

1. Technical Field

Methods for contextual processing of data objects in a multi-dimensional information space are disclosed. The methods can be applied in the fields of information analysis, such as dynamic context-based analysis, information discovery such as internet search or enterprise search, information management, such as content management, document management or file management or in the field of information networks, such as social networks or dynamic content-based networks. Systems for performing the aforementioned methods are also disclosed.

2. Description of the Related Art

Algorithmic search methods facilitate the retrieval of information via indexation methods based on manual or automated input of queries such as search terms or location based queries. Indexing typically has only one dimension with an associated information structure attached to it and is typically limited to a particular domain. Indexing is based on associated tagged or key words.

Social networks facilitate the discovery of relevant or potentially relevant information by peer group recommendations.

File management displays parent-child folder associations. They keep other relevant associations between data objects, including explicit hyper-link associations, hidden.

Documents can be indexed. For example, documents may be tagged with dimensions, such as author, editor, and keywords. but if a comparable case with similar patent domain came up in the context of a colleague's interaction a year from now, this document would not necessarily show up in a key word based search (e.g., if the author's name or the case file name is not part of the document's key words) or would yield too many results for the user to reasonably sort them, such as the entire history of a customer or business matter.

In all cases, the lack of precision leads and the hidden associations to efficiency losses.

Procedures for processing data objects in context are known, for example, in U.S. Pat. No. 7,634,482 (the '482 patent) to Mukherjee et al., issued 15 Dec. 2009, titled “System and Method for Data Integration Using Multi-Dimensional, Associative Unique Identifiers,” on procedures associating data objects utilizing unique identifiers. Data objects are modeled utilizing data object ontology, such as in U.S. Patent Publication No. 2007/0255735 A1 to Taylor et al, published 1 Nov. 2007, titled “User-Context-Based Search Engine.” Data extraction tools mine information from the information source, organize the information, or the location of information within a database, for example as described in U.S. Patent Publication No. 2010/0228711 A1 to Li et al., published 9 Sep. 2010, titled “Enterprise Search Method and System.” Personal information from an Active Directory and data extraction services extracts metadata from documents on the Intranet and use both for searching FAQ relevant documents and experts, for example as described in U.S. Patent Publication No. 2009/0204581 A1 to Lim, published 13 Aug. 2009, titled “Method and Apparatus for Information Processing Based on Context, and Computer Readable Medium Thereof,” and U.S. Patent Publication No. 2008/0172364 A1 to Cucerzan et al, published 17 Jul. 2008, titled “Context based Search and Document Retrieval.”

Procedures for manipulation of data in multiple dimensions are also known, such as, e.g., the '482 patent, where one business object ontology may correspond to a representation of a customer from a financial perspective while another business object may correspond to a representation of the customer from a physical presence perspective, and U.S. Pat. No. 6,366,299 to Lanning et al., issued Apr. 2, 2002, titled “Multidimensional Information Virtualization Using Attribute Rods.”

Procedures are also known for relating data objects to one another, such as indexing, tagging, hyperlinks or folder structures, such as described in U.S. Pat. No. 7,464,091 to Conrad et al. issued 9 Dec. 2008, titled “Method and Software for Processing Data Objects in Business Applications.” As an example, data objects may be implemented as one or more fields of one or more tables, particularly of tables of a relational data base system, such as described in U.S. Publication No. US 2003/0172368 A1 to Alumbaugh et al., published Sep. 11, 2003, titled “System and Method for Autonomously Generating Heterogeneous Data Sources Interoperability Bridges Based on Semantic Modeling Derived from Self-Adapting Ontology” and U.S. Pat. No. 7,761,480 to Toledano et al., issued 20 Jul. 2010, titled “Information Access Using Ontologies,” U.S. Publication No. 2006/0036659 A1 to Capriati et al, published Feb. 16, 2006, titled “Method of Retrieving Information Using Combined Context Based Searching and Content Merging,.” and also described in U.S. Publication No. 2009/0171938 A1 to Levin et al, published 2Jul. 200, titled “Context-Based Document Search.” All of the aforementioned patents and applications are also incorporated by reference herein in their entireties.

Discovery of information relevant to human interaction becomes increasingly difficult with increasing data volumes, multiple data repositories, heterogeneous technical platforms and multiple devices. Related known methods for efficient information management such as indexation, tagging, structured queries, folder structures, workspaces, subscriptions, peer recommendations in social networks, etc. aim to facilitate the discovery, retrieval and presentation of data relevant to an interaction.

Another existing challenge is the dynamic adjustment of information relevance. Existing systems have a limited or non-existent capability for information repositories to dynamically modify the relevance of data objects. While content or records management systems do offer the possibility to define retention times and allow for the archiving or the deletion of data, the present art does not allow for a dynamic adjustment of information relevance.

### SUMMARY OF THE INVENTION

A method is disclosed that establishes multimodal (e.g. multiple input devices, such as computers mobile devices, phones, voice, browser, photographic devices, etc.) and cross-platform (e.g. For example, Microsoft Windows on the x86 architecture, Linux on the x86 architecture and Mac OS X on either the PowerPC or x86 based Apple Macintosh systems. A cross-platform application may run on as many as all existing platforms, or on as few as two platforms) usage histories to generate contextually relevant data objects and services. The method creates associations between data objects (e.g. documents, communications such as e-mail, a file, a contact, etc.) to dynamically create a multi-dimensional information space based on U.S. Pat. No. 7,085,772 to Sternemann (the '772 patent), issued 1 Aug. 2006 and incorporated by reference herein in its entirety. The '772 patent discloses methods for processing data objects.

A system and method is disclosed that can dynamically create and update (e.g. automatically and/or manually) associations between data objects in a multi-dimensional information space based on user actions, system based processing, system or application services and/or semantic services (such as content and/or context analyzing technologies and/or similarity information) including the dynamic creation of subordinate information spaces based on the processing of primary data objects or the dynamic actions taken in context of those primary data objects.

The method and system can use associations and criteria for relevance to contextually identify associated data objects based on associations between those data objects.

The method and system can contextually display and allow for navigation of data objects based on the associations between those data objects.

The method and system can allow for processing of those data objects and dynamic association of actions based on those data objects, the associations between the objects or the usage of those objects within an information space.

The method and system can automatically adjust information relevance of specific data objects or groups of data objects and their associations through algorithms or rules.

The method and system can allow for management of the permissions associated with the data objects (such as access rights, editorial rights, deletion rights, processing rules, etc.).

The method and system can dynamically adjust relevance procedures for dynamic adjustment of information relevance through algorithms or rules that constitute filter criteria for the selection, display or manipulation of specific data objects and/or groups of data objects and/or the associations between the data objects or the groups of data objects.

The data objects can be virtual or physical objects or combinations thereof. A larger information space containing multiple data objects can itself be partitioned into multiple smaller information spaces contained within or related to a larger one. Data objects can be represented logically using discrete taxonomies and/or discrete structural representations or hierarchies. User-specific structuring of data objects can be achieved irrespective of their physical storage location. Sources of context can be semantic, temporal, social or procedural or combinations thereof. Context can be identified from user or system actions, such as communications, location, roles, rights, content, etc. or combinations thereof.

The disclosed procedures can be performed by a system having one or more processors, such as in a computer, mobile device, a network of computers, cloud computing environments or combinations thereof.

The method can apply irrespective of data provenance, such as the Internet, software applications, social networks or any other structured or unstructured data repository or location, such as local file systems, mobile devices, servers or centrally hosted databases or access method, such as the internet, LAN, WAN, phone line, mobile air interface or wireless internet connection or combinations thereof.

Any interaction can generate the received data to update the location of a data object in a multi-dimensional information space. The received data can be analyzed by processes on the processor to analyze the context and the content of the received data.

The system can analyze the context and the content to identify related data objects to the received data. Interactions between a first user and a second user can produce the received data. The received data can be written, aural, visual (e.g., graphics), or combinations of uni-sensory or multi-sensory data. The context can be multi-dimensional, for example with the data objects being categorized in three or more dimensions.

The object data can be identified by context- and/or content-derived vectors mapped into a multi-dimensional space in which the object data is organized. The treatment of the object data can then be based on multi-dimensional interactions, context, content and identification technologies. A given interaction between a first user and a second user can produce contextual data.

The received data can also be a data object produced by one or more users, such as a word processing file (e.g., a Microsoft Word document), a spreadsheet, a contact information file (e.g., a v-card), a calendar information file, a task or to-do file, a note file, a voice memo, pictures, snapshot, feeds, websites, etc. or combinations thereof. The received data and process context or user interaction information can be analyzed by processes on the processor to analyze the content (e.g. with semantic services) and the context of the received data.

The system via the processor can analyze the context or user actions (e.g. Person creates Document, or Document is used in Meeting) to identify (e.g., search/find) related data to the received data. The identification can precede treatment of the related data and/or received data.

### BRIEF DESCRIPTIONS OF THE DRAWINGS

FIG. 1 illustrates a user interface to present meta data, pre-views, action options and associated information objects.

FIG. 2 illustrates a semantic network with corresponding connection matrix.

FIG. 3 is a schematic representation of possible associations between the information object in an information space.

FIG. 4 is a schematic representation of a three-dimensional information space.

FIG. 5 a representation of the concept of vectors (e.g., locate or control) and the nearby discovery options to find additional or associated information objects in an information space.

FIG. 6 illustrates a user interface to present associations, hierarchy views, meta data in according to a person.

FIG. 7 is a schematic representation of a variation of the system elements or components and the interactions therebetween.

FIG. 8 illustrates a user interface for control and structure/hierarchy views as add-in sample in an Office environment.

FIG. 9 is a schematic representation of the architecture overview showing layers, building blocks, components and the connections between these elements or components.

FIG. 10 illustrates a variation of the process and sequence of actions and operations in according to FIG. 9 to handle UI elements and data objects.

FIG. 11 illustrates a variation of the connection diagram of an information object (entity), actions, operations and relationships between actions.

FIG. 12 illustrates a variation of the method for managing meta data in an operation.

### DETAILED DESCRIPTION

A system and methods are disclosed that can dynamically create and update (e.g. automatically and/or manually) associations between data objects in a multi-dimensional information space based on user actions, system based processing, system or application services and/or semantic services (such as content and/or context analyzing technologies and/or similarity information) including the dynamic creation of subordinate information spaces based on the processing of primary data objects or the dynamic actions taken in context of those primary data objects. The system can have a computer or network of computers with memory and one or more processors. The method can execute as software performing manipulations on the memory of the computer, or as an instruction set on the hardware or hardware architecture.

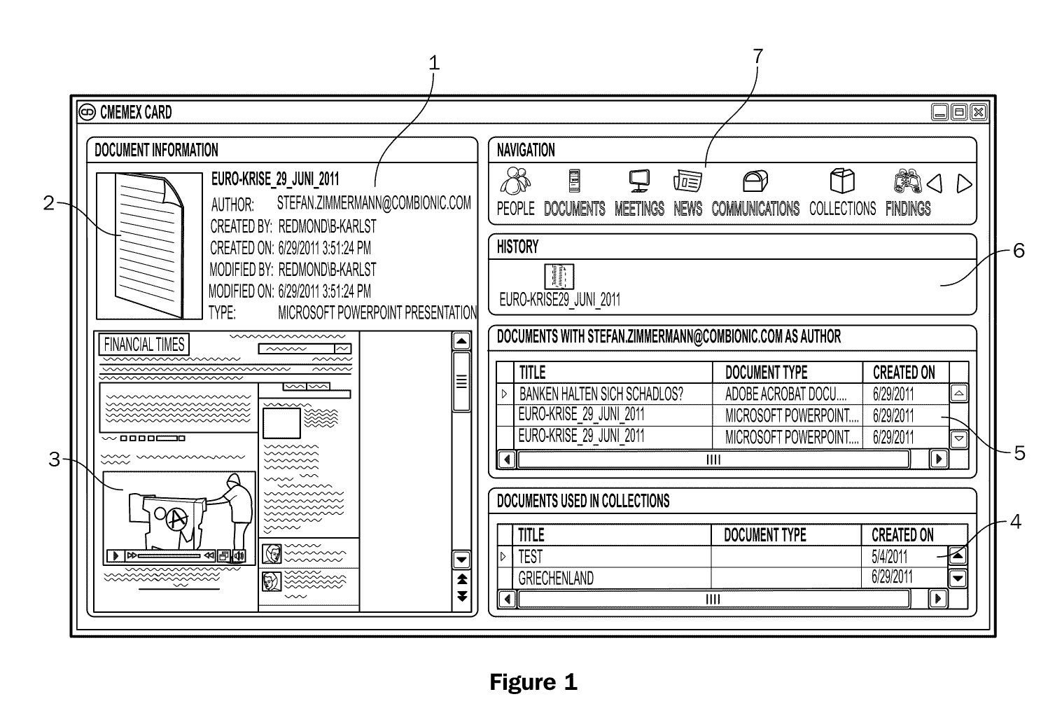

FIG. 1 illustrates a graphical user interface window driven by the system that can have an information object meta data 1, for example file or data object information such as a title, author, creation date, or combination thereof. The window can have a thumbnail information object 2, such as a document type. The window can have a preview information object 3. The preview information object 3 can be fully navigable. The window can display associations to files (e.g., documents) 4, such as a description of related collections of documents to the file for which the thumbnail information object 2 is shown. The window can display associations to files (e.g., documents) with dedicated Person as Author 5. The window can have a navigation and/or discovery pane 6. The pane 6 can show visits and user actions during a “working session”. The pane 6 can be navigable with back/forward commands. The window can show available options 7 (e.g., actions or focus on).

The system can use associations and criteria for relevance to contextually identify associated data objects based on associations between those data objects. The system can contextually display and allow for navigation of data objects based on the associations between those data objects. The system can allow for processing of those data objects and dynamic association of actions based on those data objects, the associations between the objects or the usage of those objects within an information space. The system can automatically adjust information relevance of specific data objects or groups of data objects and their associations through algorithms or rules. The system can allow for management of the permissions associated with the data objects (such as access rights, editorial rights, deletion rights, processing rules, etc.)

Any of the methods for processing data objects disclosed in the '772 patent can be used in conjunction with any of the methods and/or by any of the systems disclosed herein. The system can position a data object within a multi-dimensional space. The object can be defined in multiple dimensions. The object can be identified and utilized in more than one of the defined dimensions.

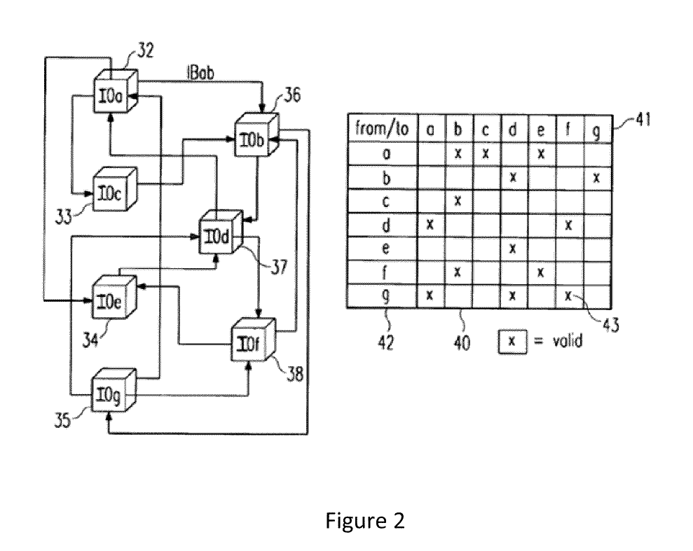

FIG. 2 portrays the concept of semantic networks between individual information objects 32, 33, 34, 35, 36, 37 and 38 with one corresponding connection space 40. In the representation, connection lines with the corresponding arrowheads show the information relationship or objects. In the execution example, the connection relationships between the individual information objects are saved in the connection spaces 40. In this example the connection spaces 40 are executed as relationship matrices. Each connection space and/or each relationship matrix has a number of rows and columns corresponding to the number of information elements in the virtual dimension, whereby the first information object is assigned row 1 and column 1, while the fifth information object is assigned to the fifth row and the fifth column.

Marking a cell in the relationship matrix of the connection space defines that a unidirectional relationship exists between the element of the corresponding row with the information object of the corresponding column. Through the relationship matrix 40 and/or the connection space 40 it can be easily ascertained, through querying the cell contents, whether an information relationship exists between two information objects.

Context can be identified from received content (e.g. text, voice, images, documents or other (e.g., image) data and/or system driven processes and/or activities and/or user actions. A system having one or more processors, such as a computer, mobile device (e.g., PDA or cell phone), network of computers or combinations thereof, can perform the disclosed procedures. The procedures and methods described herein can be executed as instructed by software and/or hardware architecture.

### DYNAMIC CREATION OF ASSOCIATIONS BETWEEN DATA OBJECTS IN A MULTI-DIMENSIONAL INFORMATION SPACE CONTEXTUAL ASSOCIATION (“CA”)

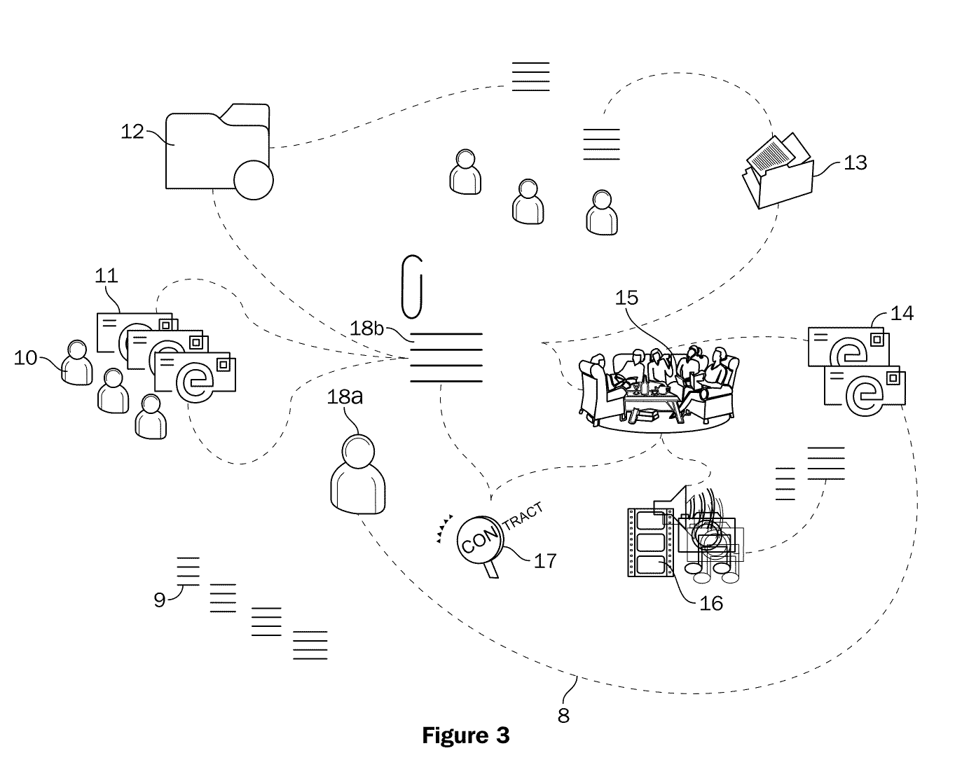

The contextual association method disclosed herein and performed on the system can organize data objects (e.g., documents, files, e-mail, websites, voicemail, contact information, files, calendar appointment files, documents such as word processing documents, pictures, videos, etc. or combinations thereof or any other data objects) with a structured relevance based on information dimensions associated with the data object, as illustrated in FIG. 3. The relevant data objects can be associated with dimensions (such as customer, case, file, domain, author, editor, time, repository, process, task, etc.) or any combination thereof “Association” is used to describe any act of associating terms describing dimensions to a data object.

FIG. 3 illustrates that the system can form a multitude of associations between objects, folders, files, individuals, documents, events, or combinations thereof For example, the system can form an association 8 between an author 18a of the information object (e.g., a focus document 18b) as a meeting organizer and meeting invitation. The system can store one or more information objects 9 associated with dedicated author 18a.

The system can also associate users 10 with e-mail documents 11 associated with the focus document 18b. The system can also store associated records 12 (e.g., records store) and associated Folders 13 (e.g., content store).

The system can associate meeting requests or invitations 14 between a meeting organizer 18a and the meeting 15.

The system can also associate meetings 15 with multimedia files or other objects 16, contracts, focus documents, folders, participants, or combinations thereof. The multimedia files 16 can be associated to meeting 15 and documents. The system can associate contracts 17 to individuals 18a, meetings 15, and the focus document 18b. The focus document 18b can be associated by the system with a dedicated person 18a as the author and additional associations, as shown.

CA can trigger the creation of an information space location using: the context of an interaction, the content of the interaction, the users, authors, affiliated people communities of the interaction, the time and/or timing of the interaction, or combinations thereof.

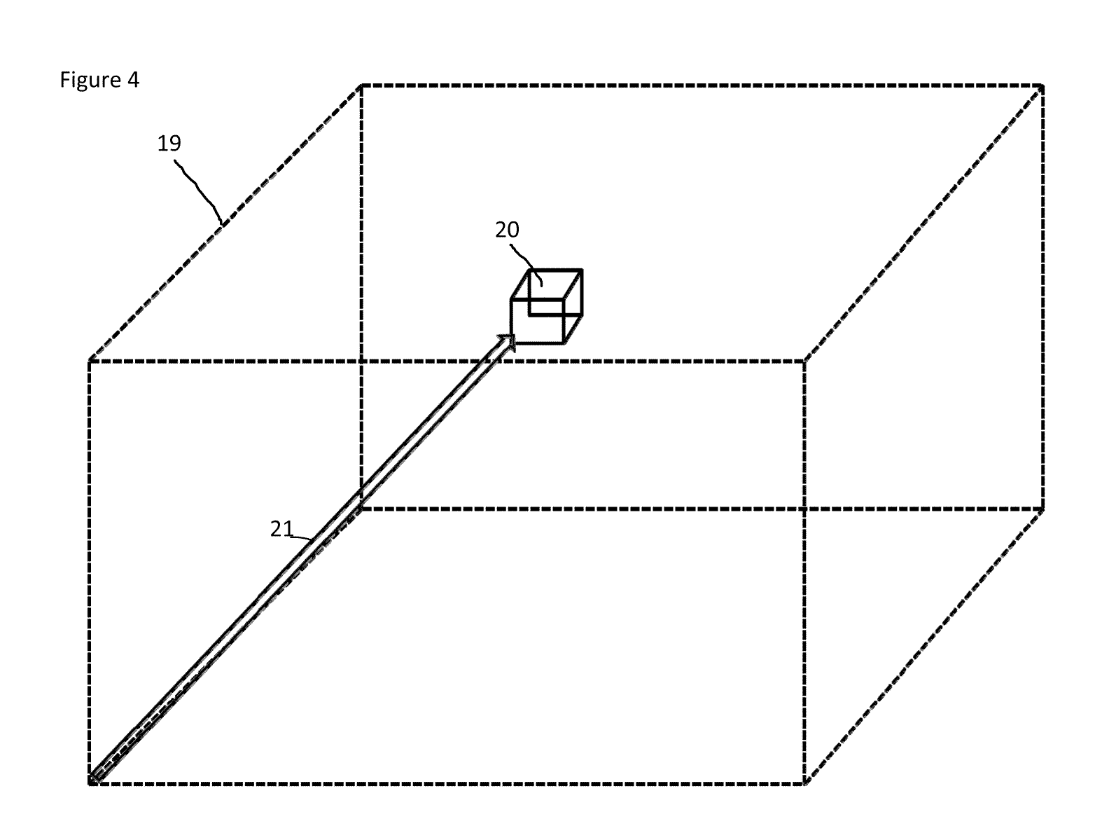

FIG. 4 illustrates that CA can define the location of an informational object in a collective information space 19. Data objects 20 can be virtual or physical objects or combinations thereof. For example an object can be digital (e.g., an e-mail), physical (e.g., a document described in terms of the object's spatial location such as maps, longitude, latitude, building, aisle, folder, like a library), or hybrid (e.g., a hospital bed with an RFID tag).

Technically, associations can occur in automated (e.g., semantic recognizers for content, tracers for users, such as location detection methods), semi-automated (e.g., through action time) or manual methods (e.g., user-named dimensions).

The collective information space of objects associated in multiple dimensions can have vectors 21 to describe the direction of particular context-based types of information. Additional vectors can describe which actions (e.g. user or system driven) are possible or allowed in a specific situation or in a specific context (e.g. process step or activity).

If some of the dimensions are missing, the search algorithm may not be able to accurately position the specific object desired, but can determine the probability of an object being relevant using the existing informational dimensions.

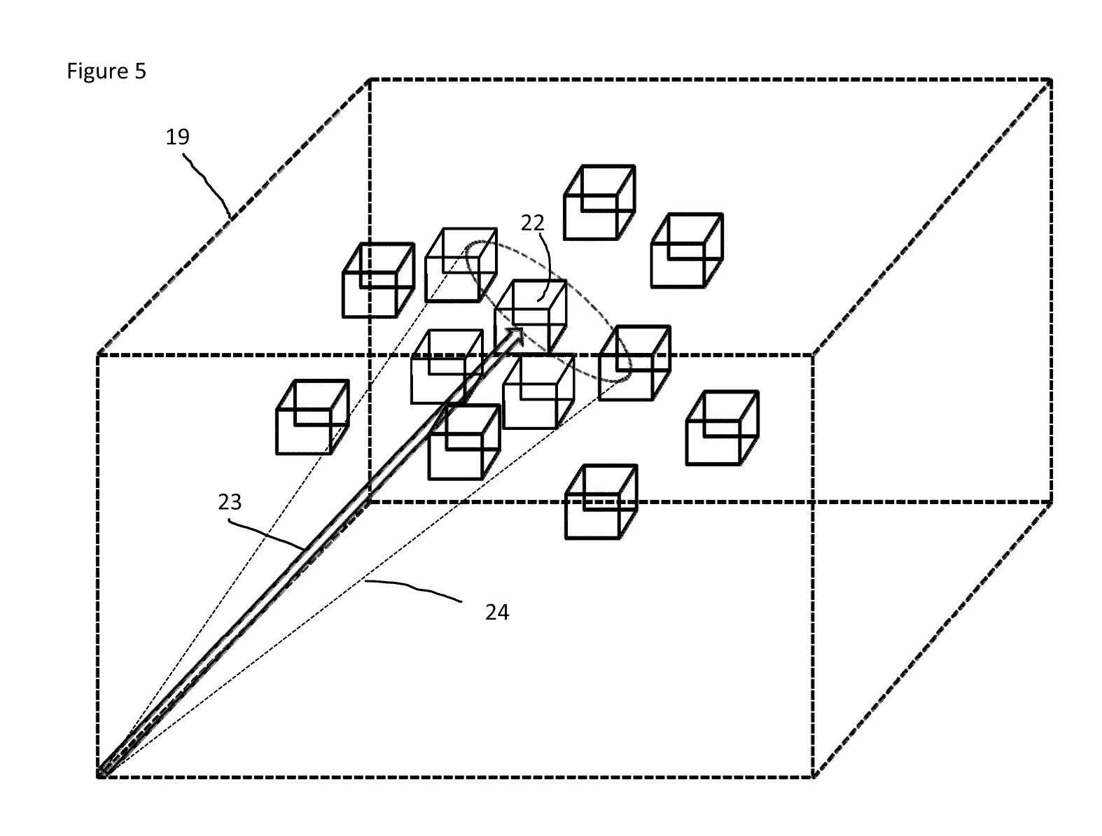

FIG. 5 illustrates that a certain informational space can be defined as relevant given a percentage probability. A radius 22 around the vector 23 given by the existing dimensions can determine the likelihood of an object being relevant. If a data object is located in proximity boundaries 24 of the vector 23 the data object can be determined as relevant. The proximity can be manually or automatically defined (e.g. by limiting the search results to a certain number).

For example, FIG. 4 illustrates a collective information space 19 (i.e., the “info space”) via a vector 21 which can identify one or more specific data objects 20. FIG. 5 illustrates that the vector 23 can be directed to an area of relevant data objects (i.e., the “relevant objects”). A radius 22 can be used to define the space proximity boundaries 24 around which the relevant objects are defined. The objects in the information space can be organized by contextual dimensions, so that nearby objects are likely contextually related. This may support the discovery of related objects in addition to the ability to search for a specific object.

A larger information space containing multiple data objects can itself be partitioned into multiple smaller information spaces contained within or related to a larger one. For example, an organization's meetings and all of its associated data objects (e.g. meeting rooms, participants, travel arrangements, documents) could be limited to meetings that occurred within a certain time period

Data objects can be represented logically using discrete taxonomies and/or in discrete structural representations or hierarchies. This allows for user (e.g. individual users, teams, organizations) specific structuring of data objects irrespective of their physical storage location. Sources of context can be semantic (Information context, application or site context) temporal (such as location or personal preferences, date and time, events), social (network associations, friends, peer groups, memberships, vocational or organizational affiliations, etc.), or procedural (process status, workflow dependent, compliance rules). Context can be identified from user or system actions, such as communications, location, roles, rights, content, etc.

The disclosed procedures can be performed by a system having one or more processors, such as in a computer, mobile device (e.g., PDA or cell phone), and a network of computers, cloud computing environments or combinations thereof.

The method applies irrespective of data provenance, such as the Internet, software applications, social networks or any other structured or unstructured data repository or location, such as local file systems, mobile devices, servers or centrally hosted databases or access method, such as the internet, LAN, WAN, phone line, mobile air interface or wireless internet connection.

Any interaction can generate the received data. The received data can be analyzed by processes on the processor to analyze the context and the content of the received data. The system (e.g., via the processor) can analyze the context and the content to identify (e.g., search and find) related data objects to the received data. The identification can precede processing or other treatment of the related object data and/or the received data.

Interactions between a first user and a second user can produce the received data. The received data can be written, aural, visual (e.g., graphics), or combinations of uni-sensory or multi-sensory data. The context can be multi-dimensional, for example with the data objects being categorized in three or more dimensions. The object data can be identified by context- and/or content-derived vectors mapped into a multi-dimensional space in which the object data is organized. The treatment of the object data can then be based on multi-dimensional interactions, context, content and identification technologies.

A given interaction between a first user and a second user can produce contextual data. For example, the first user can e-mail the second user producing the received data of an e-mail. Also for example, the received data can be a text message, transcribed voicemail, or combinations of any of the aforementioned.

The received data can also be a data object produced by one or more users, such as a word processing file (e.g., a Microsoft Word document), a spreadsheet, a contact information file (e.g., a v-card), a calendar information file, a task or to-do file, a note file, a voice memo, pictures, snapshot, feeds, websites, etc. or combinations thereof.

The received data and process context or user interaction information can be analyzed by processes on the processor to analyze the content (e.g. with semantic services) and the context of the received data. The system (e.g., via the processor) can analyze the context or user actions (e.g. Person creates Document, or Document is used in Meeting) to identify (e.g., search/find) related data to the received data. The identification can precede treatment of the related data and/or received data.

### CONTEXTUAL IDENTIFICATION OF DATA OBJECTS BASED ON ASSOCIATIONS BETWEEN DATA OBJECTS

The method can execute a dynamic, context-based identification of related data objects. The location of related data objects can be described in multiple dimensions, hence optimizing the accuracy of the location of the object. For example, adding more coordinates helps knowing how the data is related and where the object is located. For example, an e-mail can be tracked after being associated along multiple dimensions, such as time (e.g., when it was send or received), logical and physical location (e.g., where it is stored), content (e.g., such as keywords appearing in the content), user rights (e.g., of the person receiving the mail, such as authorization of the user to read, write, or modify the file), or other independent dimensions as well as any combinations thereof.

The disclosed method can include a search and find algorithm. The search and find algorithm can search and find information based on approximation of location of information in space, such as illustrated by FIG. 5. The algorithm can be based on calculating scalar vectors and defining adjacent information spaces. The algorithm can use the /associations established through the CA method.

For example, the search and find algorithm can limit results to objects within a date range within the radius, such as illustrated by FIG. 5, as time can be an information dimension. Out-of-band objects can be excluded from the search result. However, out of band may not equal out of date or out of interest. Out-of-band could refer to outdated documents, but if a historical search is performed, older data objects could equally be relevant and useful. Inversely, it may be relevant what was stated at a certain point in time, but it may not be retrievable anymore because the content may have been altered in the meantime. For example, one cannot quote from a web site that doesn't exist anymore or whose content has been altered. Information may be out-of-date, but in-band, and therefore relevant to find.

CA also provisions for the storage of the data object (such as the text of the website) to be retrievable at a later stage, instead of storing the link to the information (such as link to website or file folder path, etc.) where one would possibly not be able to retrieve the original information, once it has been altered or deleted. The method can also cover the ability to compare an original with unaltered version of an object and describe the differences between the original and the altered object.

The associations between objects may have discrete strengths. Objects may be directly associated or indirectly associated. Direct relations may be stronger, indirect relations may be weaker.

Data objects may be part of a typology of objects (e.g. a person, a meeting, a document).

The representation of an object may be in relation to the object itself, but also to its type.

The representation of an object or an object type may be altered dynamically, based on context. Variable solutions that serve objects in relation to the object type. For example, a person could trigger different info types or data objects.

Extensibility: dynamic extensibility of services in relation to data object, data objects type or information space. For example, an information space of “overseas meetings” could trigger a reservation service to reserve meeting rooms, hotel accommodation or flights.

The method includes usage of associations and usage of filters of relevance in context of an interaction

The method includes creation of additional associations based on the user discovery path within an information space (e.g. personal or general information space).

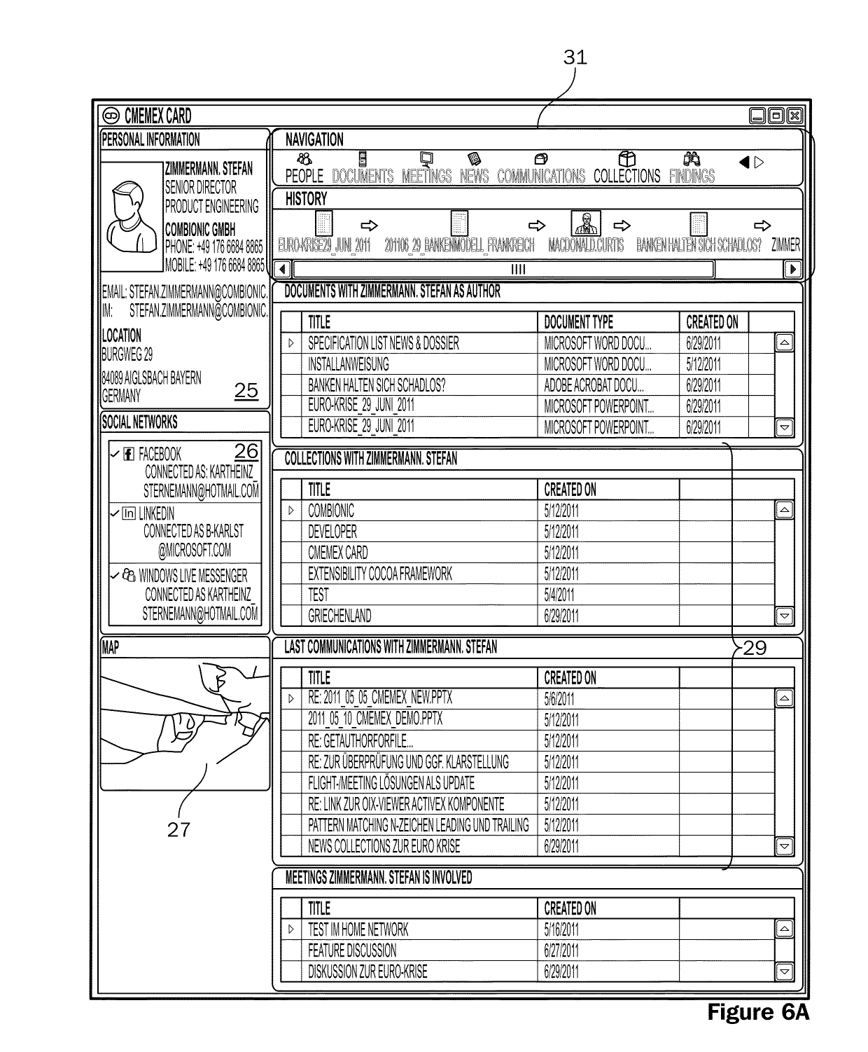

FIG. 6 illustrates a graphical interface window that illustrates that the system can perform and method can include deduction of information relevance based on the user discovery paths. The window can show information object details and/or meta data 25, such as a person with the person's name, address, contact information, or combinations thereof The window can show association to social networks 26., a map 27 based on address information in 25, meta data of the focus object 28 (e.g. a document file), such as a title, created on time and date, a reference path, or combinations thereof, and associated objects 29 such as a meeting the person was involved in, last communications independent of the communication application (e.g. summary of MSFT Outlook, g-mail, Facebook, LinkedIn, or combinations thereof), collections, workplaces or logical libraries with the person (i.e., secondary associations) and associated documents with the person as the author, or combinations thereof The window can also show a selection of associated collections of data objects 30 and the associated history 31.

### DYNAMIC, CONTEXTUAL DISPLAY AND NAVIGATION IN PERSONALIZED UI'S OF DATA OBJECTS BASED ON THE ASSOCIATIONS BETWEEN THOSE DATA OBJECTS

The method can automatically create relevant associations between data objects 30 and can deliver services to have access to these data objects and their relations , such as shown in FIG. 6.

The method can integrate sources into a logical single view regardless of where the information originated or the physical repositories of the data objects 29.

The method allows for a dynamic rendering and modification of the user interface as a function of for example, user rights, context, content, task, role, process, etc.

Within the user interface of a host application (e.g. Web browser, Microsoft Office system application, Adobe Acrobat Reader etc.) etc.) A framework based application can be embedded, such as the add-in in Microsoft Office as Task Pane in which the focus object 28 is displayed, that constitutes the presentation and execution framework for presentation and execution assemblies (pre-compiled assemblies or similar software code) described through metadata.

The presentation and execution assemblies can be deployed on a client, on servers, within a network or in a cloud environment. The assemblies can load from any storage path.

The presentation and execution assemblies can be persisted by rules (e.g. by user groups, geography, content, etc.) and can be managed in distributed or centrally administered structures and/or through near-by caching methods.

The presentation and execution assemblies 71, 72 can contain references to external metadata storage locations 73, 74 or combine local or central or distributed storage methods.

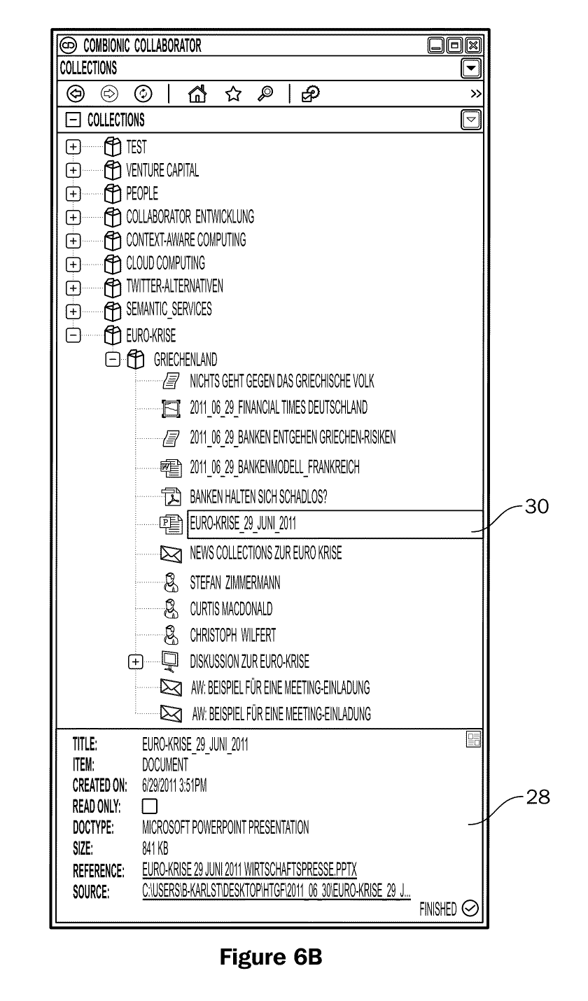

The data can be based on a one-time deployment of a framework. For example, no deployment of the full client is needed. The system can have a mechanism to automatically add assemblies (e.g. NET assemblies or other) during runtime into the AppDomain, such as shown by b in FIG. 7. The system can have a mechanism to automatically add .NET Assemblies outside the search path during the “assemblyresolve phase” into the AppDomain at runtime (see above for dependent files in the cache).

FIG. 7 illustrates that the system can completely encrypt files in the cache 46.

The method can include caching of a dynamic user interface. For example, the presentation of at least a portion of the identified object data (e.g., contact information for a specific e-mail) and associated actions can be cached and visually displayed to a user without the deployment of the full client.

The caching can be performed for received data 47, object data 49, 47, executable code 49 (e.g., assemblies for operations, metadata), dependencies (e.g., assemblies for other files) and combinations thereof.

The assembly can be put together by compiling data, code, meta-data of the present service, metadata of different services, and combinations thereof. The assembly can then be cached, for example to allow the application to execute when off-line. For example, the local system can receive the interface assembly (e.g., as a Microsoft Office add-in) from a server or from a network location 48. The interface assembly (including an interface template) can then be cached. Then, for example, if using the application at an off-line location (e.g., while on an airplane with no network access), the application can still display the desired object data.

The system can display any data format and user options or user actions ordinarily available, whether online or not. The cashed data can be stored locally or centrally (e.g. cloud storage, or device based storage or stored between central and locally managed devices (e.g. servers and clients).).

The system allows for in-memory storage of dynamic interface and associated actions (see above). This allows for navigating back/forth to previous views. The views may be in a ring buffer, to minimize memory consumption.

The system can be integrated with existing software applications (e.g., Microsoft Office, Microsoft Outlook and/or Web Browser or Adobe Acrobat or Acrobat reader, SAP, Oracle, etc.) and as a stand-alone-application.

The system can perform a linguistic analysis of the documents generated in the host application.

The system can search within a selected text area, cell area, shape, slide area, or combination thereof in the received data object (the received data object can be received from a second user or an object created by the first user and not received from another user). The system can search in the complete object (e.g. document, mail, workbook, presentation, or combinations thereof).

The system can analyze the context of the document. The system can then identify relevant object data, and direct navigation of a peripheral window to display relevant portions of the object data based on the analyzed context (e.g., focused on the user's point of view).

When the system identifies multiple relevant object data entries, the system can display the contextual data object list to the user. The user can select the most appropriate context to focus the search and/or review the entire list.

Regarding the GUI window layout, the system can create or build composite window or sub-window views on the same object model within a host application (e.g., multiple panes can be opened on the side of Microsoft Outlook to display a variety of information from one or more object data) as shown by the windows in FIGS. 1, 6 and 8. For example, the system can display events and status changes within all views. The software and displayed views can occur within the host applications (e.g., Microsoft Office System applications).

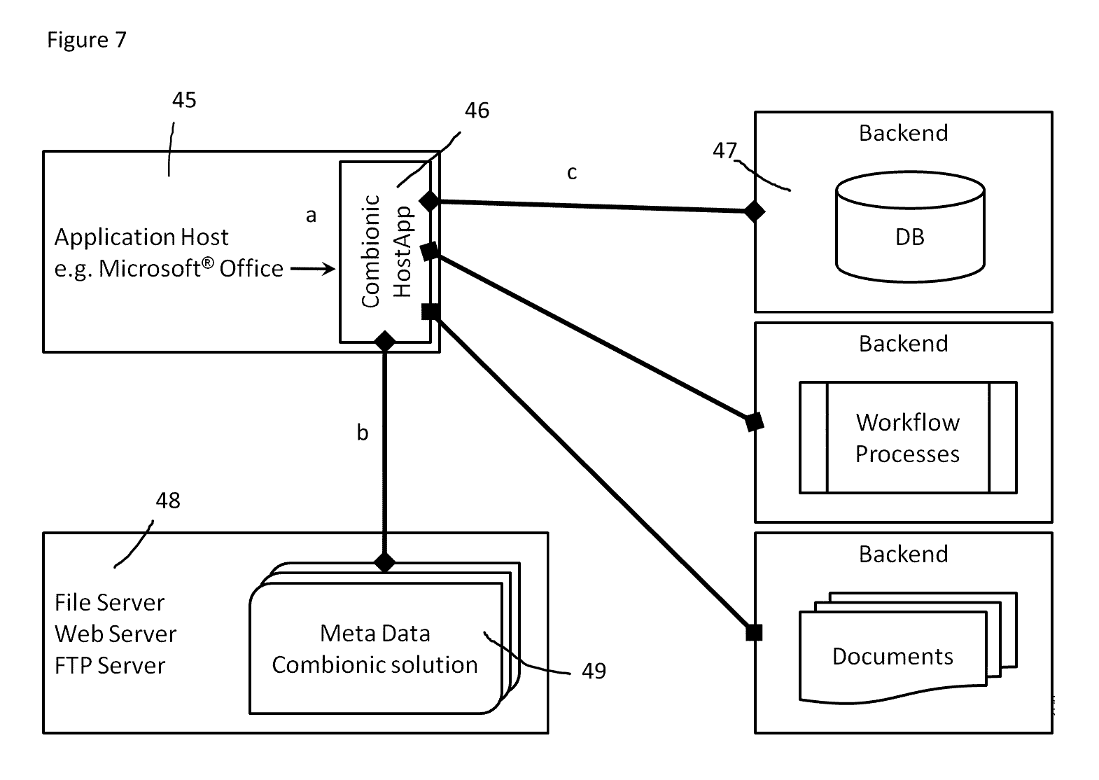

FIG. 8 illustrates a GUI window showing collections 50, a selected file 51 within the collection, and a pane 52 showing data correlating to the selected file, such as the title, the file type, the created on date and time, the document type (e.g., Microsoft PowerPoint), the file size, the reference or full file name, and the source address.

The system can build and display composite views, such as shown in FIGS. 1 and 6.

The software performing the method can be executed within a generic platform that can allow the building of add-ins (e.g., Microsoft Office Business Application foundation for Microsoft Office System applications). The system can build and display composite views of information for display based on the same generic platform.

Changes to the layout can be made and displayed in real-time in one view while concurrently shown in another view. The user can move different visual displays using the same object model. The system can display a composite view of the applications on the same object model.

The composite views can be informed by a given interaction, the context being informed by recognition technology (e.g. a context recognition technology described here or an alteration of a third party or a blend of the two).

The system can show the layout on a display on a cell phone or landline phone. The method can be performed on a mobile device (e.g., tablet, smart phone, mobile phone, IPad, IPhone, etc.)

### PROCESSING OF DATA OBJECTS AND DYNAMIC ASSOCIATION OF ACTIONS BASED ON THOSE DATA OBJECTS OR THE ASSOCIATIONS ASSOCIATIONS BETWEEN THE OBJECTS

The system can categorize data objects using metadata descriptions compiled in the assemblies at run time. One of the dimensions of the data objects can be meta data. The assemblies can provide metadata statically (e.g., by the system's designer generated objects) and/or dynamically from variable data sources generated dynamically at run time, such as during operation 72 for data store pointer 73

For example, four actions can be chosen in a project stage. Once a priority message is received, the interface can change using the metadata from outside the application, such as using pointer 73 to retriece data 74.

The system can dynamically adapt or change authorizations based on contextual information (e.g., from CACA dimensions), such as changing the relationship 69. For example, permissions to view, create, edit, modify, delete, or combinations thereof.

The user identity can be based on authentication from a third party system (e.g. a software application or operating system). The system can implement authorizations as designed by developers. The system can provide permissions for all objects or for a selection of objects, such as permission action 68 executing permission operation 72 on pointer 73 and data 74.

A developer can build the developer's own components to set permissions to determine use levels (e.g., as an operation).

The system can have a default permissions model available (e.g., read, write or act permissions and full/all permission). A permissions model used by the developer can contain self-defined states (for example personas)

Metadata information can be processed in real time or asynchronously as informed by the context of the interaction (i.e., received data). Dedicated services can create additional new metadata and context information as relations (e.g. m:n—multidimensional) between the data objects. For example, as a user receives and/or opens an e-mail file, the system (e.g., via a software process executing on a processor) can not only identify previous communications (e.g., e-mails, voicemails, text messages, or combinations thereof) that have been sent to and/or received from the sender of the e-mail, but also build additional or new relations between the system elements (e.g. between a contact, an e-mail, an attachment to the e-mail or other content parts). The system can read the metadata associated with those communications when a data object (e.g. the e-mail) is selected or received or opened.

An event handler system (complex event management system) based on the action vector described in the '776 patent (at least one pointer data that is characteristic for the position of at least one data object in the data space; and at least one property data for at least one virtual dimension of said information space; wherein at least one set of instructions is provided with at least one instruction for the processing of said data object).

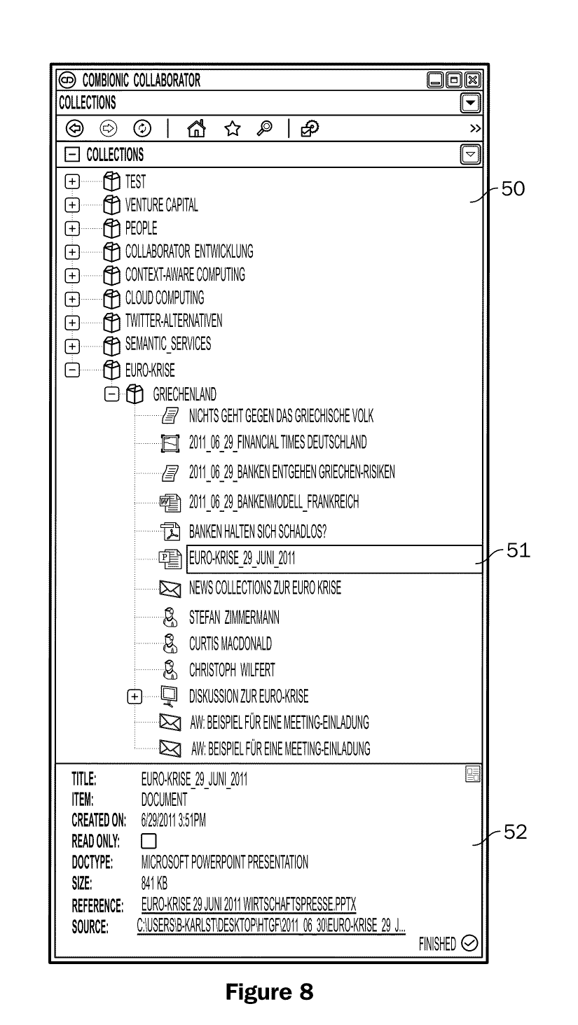

FIG. 9 illustrates that the system can have a computing engine 53 as well as a set of connectors and connection services 58 that allow access and retrieval of data objects from backend applications and content stores 12. The system can also have caching services 54, logical middleware 55, configuration data memory and/or database 56, local data store memory and/or database 57, and content and data sources 59, or combinations thereof connected in data communication as shown in FIG. 9.

The method extends as a platform with related event handling capabilities (e.g., as shown in FIGS. 9, 10, and 11) for the use of data objects and associations with a variable number of data objects and associations. The patent describes the formation of an information space. The elements of the control vector and the associations between data objects are relevant to portray the value of the extensibility.

A set of instructions via pointer or virtual connection (an instruction vector) with the data object defines which actions are possible or permitted on a data object.

The applications of the extensibility platform describe their relative information requirements in analogue form. There are now two vectors: a vector of the information object and its associations to other information objects (a property vector) and a vector of a discrete application, for example “meeting management” that defines the position (a position vector) an information object must be located in, to be relevant for the respective application.

The relations between the information objects are typed and therefore offer the possibility to react specifically. They can be extended for future use.

An example can be meeting management: the user defines an action such as “new meeting” in the user interface of the meeting management application. This information object “meeting xyz” is added to an information space. This activates the association services coupled with this application. These services activate the potential and relevant associations between the data object “meeting”, other data objects, such as the meeting organizer, the participants, etc. and puts the information vector at the disposal of the extensibility platform. The meeting application recognizes the relevance of this information vector in the event space and launches relevant services caused by this information and the metadata of the information vector. In the meetings example these services could consist of services for the creation of a meeting agenda, participation requests, handover to a calendar (e.g. Microsoft Outlook), notification of all participants, set-up of a central document repository (e.g. Microsoft SharePoint), creation of templates (e.g. documents, e-mails, notes, etc.) as well the reservation of a meeting room (physical or virtual).

### DYNAMIC ADJUSTMENT OF INFORMATION RELEVANCE

The method permits dynamic adjustment of information relevance through algorithms and/or rules that constitute filter criteria for the relevance of specific single data objects or groups of data objects or associations between data objects or groups of data objects. The dynamic adjustment of information relevance can for example be permanent, temporary, gradual, linear or non-linear or any other method of adjustment.

The method can determine relevance on the basis of contextual informational value [IV] within an information space as defined by patent '776, whereby

IV (io)=f[UAR (ud)+∫AR (a)+eSR (io)+EXP {TR (io)}+FR (ud)+FR (uc)]

### With

[AR]=association relevance

[eSR]=extended semantic relevance

[TR]=temporal Relevance

[FR]=frequency relevance

[UAR]=User Activity relevance

IV=Information value

(io)=Information object

(ud)=dedicated user

(uc)=User community

The user interaction with the data object can be analyzed in context and attributed to the user activity relevance [UAR] parameter of the algorithm to determine its information value [IV]. The associations formed between the data object and the other data objects in the information space can jointly form a definite integral (math) function and can be attributed to the association parameter [AR] of the algorithm to determine the information value [IV].

The extended semantic relevance [eSR] can be attributed through analysis/monitoring of the information space (e.g., the personal, team, or organizational information space) as well as the semantic and/or linguistic analysis of the data object in question and attributed to the extended semantic relevance [eSR] parameter in the algorithm to determine information value [IV].

The BM25 Corpus (or the Internet as a body of data) can be focused on a personal body of data (e.g. in the context of a process, task, or role, etc.)

The temporal relevance [TR] can be formed on the basis of retention times (e.g. legal retention times for records, rules based retention times, archiving rules, etc.). The parameter of temporal relevance can be used as half-time function in the algorithm to determine information relevance [IV].

The frequency relevance [FR] can expand the information value [IV] by usage and access frequency parameters of a dedicated user or groups of users within the monitored information space.

### MANAGEMENT OF THE PERMISSIONS ASSOCIATED WITH DATA OBJECTS

is a schematic representation of the flow and the access to the components and services described by metadata for the dynamic execution on the client of system or user actions 60. Every action 60 can have at least one operation 61 made available by pre-compiled assemblies 62, 63, 64, 65, 66 based on the principles outlined above.

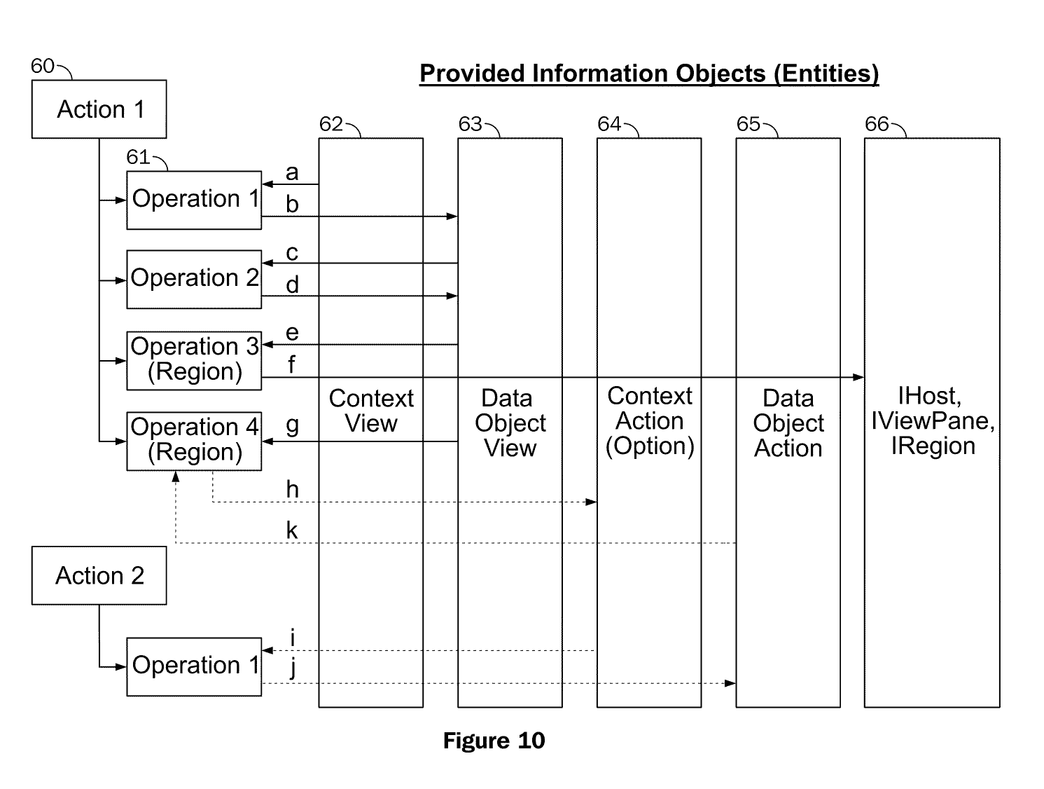

FIG. 11 illustrates that the actions 68 based on operations 70 are described through metadata. The actions 68 are loaded from the cache or from a central repository at runtime and executed within the client without need for additional deployment of the client component.

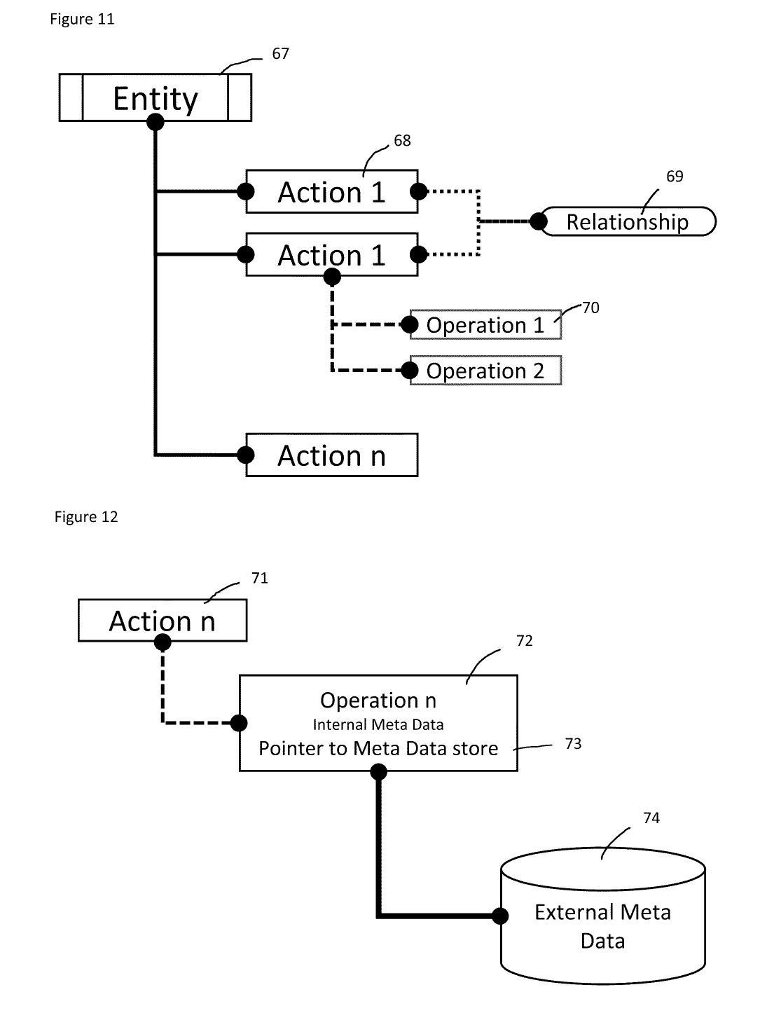

FIG. 12 illustrates that every operation 72 may include pointers 73 that can be updated or modified through external services 74 without the need for modifications or new compilations. The operations 72 can be triggered by actions 71.

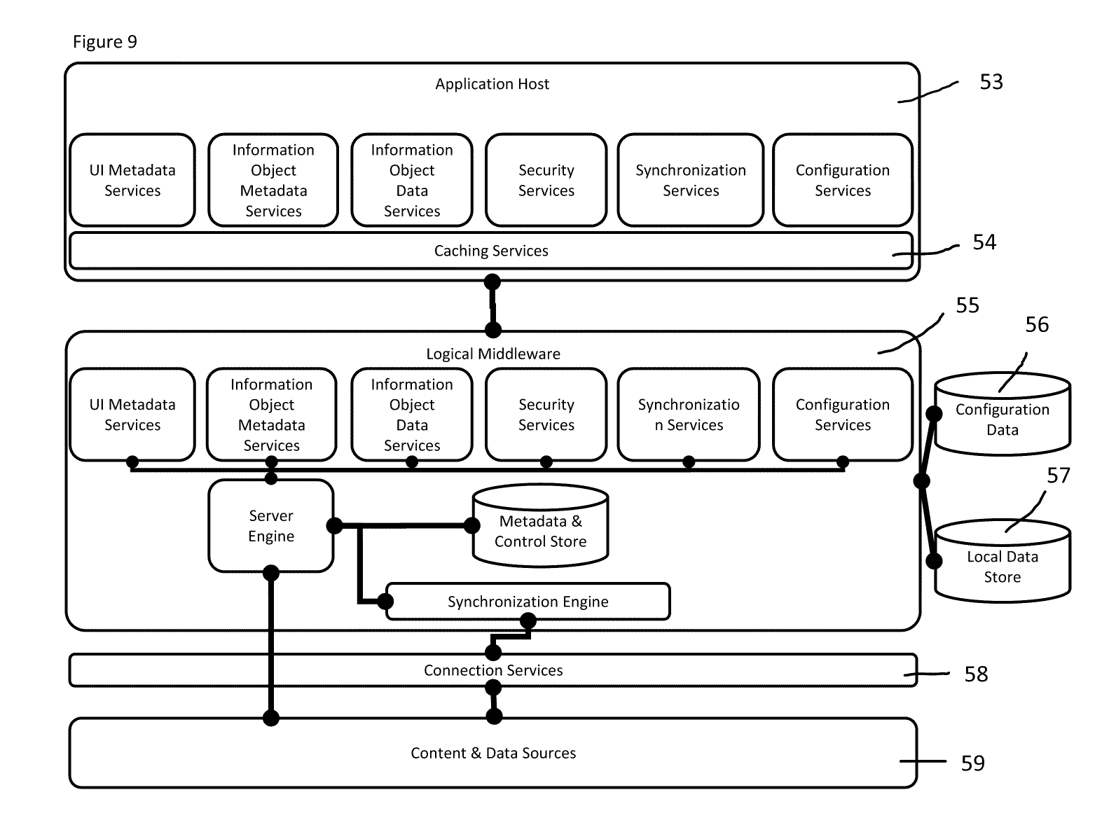

This concept allows for access to a single data object, the visualization or manipulation of the object by combining sequences of operations (e.g., a-k as shown in FIG. 10) to form dedicated actions 61. With pointers from individual operations to external sources of metadata, the respective criteria for action, visualization or manipulation can be adjusted dynamically

For example, the system can be set so a first user can have full access to information, such as a document. A second user can see that the information itself exists or that actions are possible, but does not have permission to see the information itself or execute the action. A third user, may not see the existence of information nor the possible options for action.

The variations disclosed herein are merely for exemplary purposes. Any of the elements or methods taught herein can be used in any combination or permutation with themselves or any of the other elements and methods disclosed. Likewise, the elements and methods can be used in singular when disclosed in plurality, and in plurality when disclosed singularly.

We claim:

1. A method for using a computer system having a processor and memory, for dynamic creation and updating of associations between data objects in the memory in a multi-dimensional information space based on user actions, system based processing, system or application services and/or semantic services, the method comprising:
creating a multi-dimensional information space that has at least two virtual dimensions and at least one third virtual dimension;
associating terms describing dimensions to data objects automatically, semi-automatically or manually;
modifying the location of data objects in a multi-dimensional information space using one or more of the data from the list consisting of: the context of an interaction, the content of the interaction, the users, authors, affiliated people communities of the interaction, and the time and/or timing of the interaction.

2. The method of claim 1, further comprising representing data objects logically using discrete taxonomies and/or discrete structural representations or hierarchies.

3. The method of claim 1, wherein user specific structuring of data objects can be achieved irrespective of their physical storage location.

4. The method of claim 1, further comprising indentifying the context from user or system actions, wherein user or system actions comprise communications, and/or location, and/or roles, and/or rights, and/or content.

5. The method of claim 1, further comprising generating with an interaction the received data to update the location of a data object in a multi-dimensional information space.

6. The method of claim 1, further comprising identifying the object data by context-derived vectors and/or content-derived vectors mapped into a multi-dimensional space in which the object data is organized.

7. The method of claim 1, wherein the received data comprises a data object produced by one or more users, and wherein the data comprises one or more files from the list consisting of a word processing file, a spreadsheet, a contact information file, a calendar information file, a task file, a to-do file, a note file, a voice memo, pictures, snapshot, feeds, and websites.

8. A method for using a computer system having a processor and memory for use of associations and criteria for relevance to contextually identify associated data objects in a multi-dimensional information space based on associations between those data objects, the method comprising the steps of:

9. The method of claim 8, further comprising executing a dynamic, context-based identification of related data objects, and locating related data objects described in multiple dimensions.

10. The method of claim 8, further comprising using a search and find algorithm to search and find data objects based on approximation of location of information in space,

11. The method of claim 10, wherein the algorithm can be based on calculating scalar vectors and defining adjacent information spaces, and wherein the algorithm can use the associations established through a CA method.

12. The method of claim 10, wherein the search and find algorithm can limit results to objects within a date range within the radius.

13. The method of claim 8, further comprising scoring the associations between objects with discrete strengths, and further comprising directly and indirectly associating objects; wherein direct associations correlate to higher score discrete strengths, and indirect associations correlate to lower score discrete strengths.

14. The method of claim 13, wherein data objects are a part of a typology of objects.

15. The method of claim 2, wherein usage of associations and usage of filters of relevance are made in context of an interaction, and wherein additional associations are created based on the user discovery path within an information space, and wherein the method comprises the dynamic extensibility of services in relation to data objects, data objects type or multi-dimensional information spaces.

16. A method for contextual display and navigation of data objects based on the associations between those data objects within a multi-dimensional information space, the method comprising:
automatically identifying relevant associations between data objects; and
integrating data objects into a logical single view regardless of the physical repositories of the data objects.

17. The method of claim 16, wherein a dynamic rendering and modification of the user interface is a function of, for example, user rights, context, content, task, role, process, etc. or combination thereof

18. The method of claim 16, wherein a framework based application can be embedded within the user interface of a host application that constitutes the presentation and execution framework for presentation and execution assemblies described through metadata.

19. The method of claim 16, wherein the presentation and execution assemblies can be deployed on a client, on servers, within a network or in a cloud environment.

20. The method of claim 16, wherein the presentation and execution assemblies can be persisted by rules, and further comprising managing in distributed or centrally administered structures and/or through near-by caching methods, and wherein a system can completely encrypt files in the cache, and wherein the assembly can be put together by compiling data, code, meta-data of the present service, metadata of different services, and combinations thereof.
